(19) United States
(12) Patent Application Publication
(10) Pub. No.: US 2002/0119370 A1
(43) Pub. Date: Aug. 29, 2002

(54) Corrosion resistant lead terminals for batteries and method of manufacture

(76) Inventors: John Lewis Ayres, Cicero, IN (US); Timothy C. Riley, Anderson, IN (US); Burdis H. Litton, Anderson, IN (US)

Correspondence Address: MARGARET A. DOBROWITSKY, DELPHI TECHNOLOGIES, INC., P.O. Box 5052, Mail Code: 480-414-420, Troy, MI, 48007-5052, US

(21) Appl. No.: 09/792,977

(22) Filed: Feb. 26, 2001

(51) Int. Cl. H01M 2/30; B05D 5/12; B32B 15/04

(52) U.S. Cl. 429/178; 427/126.4; 427/126.1; 428/469; 428/472.2

(57) ABSTRACT

A thin film or coating containing an oxide of silicon or aluminum or both is deposited over lead or lead alloy battery components that will be in contact with the acid electrolyte greatly reducing the corrosion of the lead components during battery use. In one embodiment, the coating of film may be applied using a colloid of silica or alumina in a binder such as room temperature vulcanized rubber. In another embodiment, the coating of film is deposited by a direct silane polymerization of an oxidized lead surface by silicic acid forming the film. The substantial reduction of component corrosion eliminates leaking around the terminals and thereby increases the service life of the lead acid battery.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention pertains generally to metal corrosion inhibiting methods, and more particularly to a corrosion resistant liquid electrolyte battery terminal post and method of surface treatment using silicon and its variants.

2. Description of the Background Art

Batteries containing liquid electrolytes have been manufactured for decades and are the primary electrical storage apparatus within an automobile. Modern automotive batteries are required to operate at higher under-hood temperatures and are placed under greater electrical production and cycling demands than in the past. These demands, among other factors, result in a reduction in the service life of the battery.

The electrolyte utilized within these batteries is normally an acid, such as sulfuric acid, which is substantially corrosive. Current production batteries typically utilize interior spun terminals made of lead metal, which are cold worked when the battery is assembled. The metallic terminals of a battery containing liquid electrolytes provide an electrical path from the grids within the electrolyte filled interior of the battery to the outside and are therefore particularly susceptible to the corrosive effects of acid. Corrosion of the metal terminals can result in leakage of the liquid electrolyte leading to an increase in the electrical resistance in the terminal and damage to the terminal connections.

It has been observed that the positive terminal tends to leak more often than the negative terminal especially in high temperature environments thereby reducing the life of the battery. Anodic corrosion of the positive terminal results in dimensional changes and stresses that can break the seal between the lead alloy terminal and the polypropylene battery case.

Some lead acid batteries are manufactured with side terminals that are positioned beneath the surface of the sulfuric acid electrolyte. This positioning of the terminals in this manner prevents sparks in the gas phase that can ignite resident gases resulting in an explosion. However, side terminal batteries are especially vulnerable to acid seepage and leakage upon corrosion of the terminals.

In lead acid batteries, a layer of oxide, approximately 0.001 inches to approximately 0.030 inches thick, is typically formed on the surface of the positive grid as well as exposed portions of the terminals due to corrosion, thus forming the corrosion layer. The composition of the corrosion layer is responsible for electrical conductivity. The positive polarization oxidation of lead (Pb) on the anode terminal and grid in sulfuric acid electrolyte solution produces a corrosion product consisting primarily of PbO₂ and far lesser amounts of PbO and PbOₓ. The corrosion layer is typically composed of a matrix of lead (IV) ions (Pb⁺⁴), and oxygen ions (O⁻²). Corrosion or oxidation of the lead metal components occurs beneath the PbO₂ corrosion layer with the free movement of oxygen ions from the electrolyte through the corrosion layer. Consequently, the PbO₂ corrosion layer provides very little protection to the underlying lead in the anodic environment of the battery.

It is apparent that unabated corrosion of the lead terminals can result in a reduced service life of a lead acid battery including electrolyte leakage. Even minor leakage of the electrolyte can cause corrosion of the outer portions of the metallic terminals and the attached electrical connectors of the automobile, such that periodically cleaning is required and the operational life of the electrical connector is reduced.

Therefore, a need exists for a lead acid battery terminal that can be easily and inexpensively fabricated while providing reduced corrosion and electrolyte leakage from the interior of the battery. The present invention satisfies those needs, as well as others, and overcomes the deficiencies of previous battery terminals.

### BRIEF SUMMARY OF THE INVENTION

A battery terminal and a method of providing a battery terminal is shown with a surface that is substantially impervious to corrosion so that battery life is extended and electrolyte leakage occurring around the terminal is virtually eliminated. Coatings of various forms of silica, preferably (SiO₂), or alumina (Al₂O₃) have been found to reduce and equalize the corrosion of lead alloy side terminals in lead acid batteries. The incorporation of SiO₂ or Al₂O₃ into the corrosion layer limits the oxygen ion movement through the corrosion layer and therefore greatly reduces the corrosion damage to the terminal.

According to the invention, silica, preferably in the form of SiO₂ mixed with a binder, is applied to a lead metal side terminal. The preferred binder is room temperature vulcanized rubber. The direct deposition of a dense layer of colloidal silica by direct silane polymerization using silicic acid is preferred. However, other oxidizable binders in the form of viscous liquids, sprays, liquids or vapor deposition and the like may also be used.

The binder functions to hold the SiO₂ molecules in place on the terminal. Later, the binder is electro-oxidized away leaving colloidal silica on the surface of the terminal. Under anodic oxidizing conditions, the rubber is oxidized while lead metal forms a corrosion layer. As the lead corrodes in the electrolyte, the silica reacts with the lead oxide, PbO, to form a lead silicate compound PbSiO₃ or [PbO].[SiO₂]. These silicate compounds are very non-conductive. Once these compounds are formed, the corrosion of the lead terminal is substantially reduced because the silicate compounds do not allow the diffusion of oxygen through the layer.

An object of the invention is to provide terminals that are highly corrosion resistant for use in a battery containing a liquid electrolyte such that the occurrence of leakage at the seals between the terminal and the battery casing is eliminated.

Another object of the invention is to provide a method for treating internal battery components and terminals that may be easily applied after fabrication and utilized in numerous battery styles.

Another object of the invention is to provide for corrosion resistant terminals and components within an electrolytic battery that can be manufactured with conventional facilities and equipment.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings that are for illustrative purposes only:

FIG. 1 is a representation of a lead metal positive terminal and the lead oxide corrosion layer that forms on the surface of metal.

FIG. 2 is a representation of a lead metal positive terminal and the corrosion layer formed in the presence silica according to the present invention.

FIG. 3 is a representation of a lead metal positive terminal coated with a polymerized thin film of silica according to one embodiment of the invention.

### DETAILED DESCRIPTION OF THE INVENTION

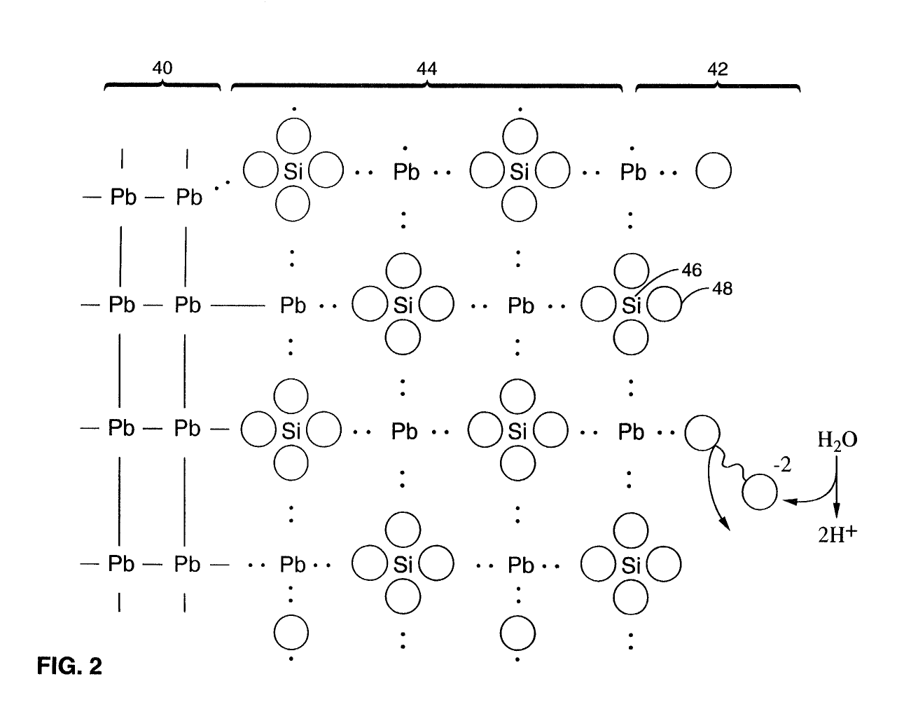

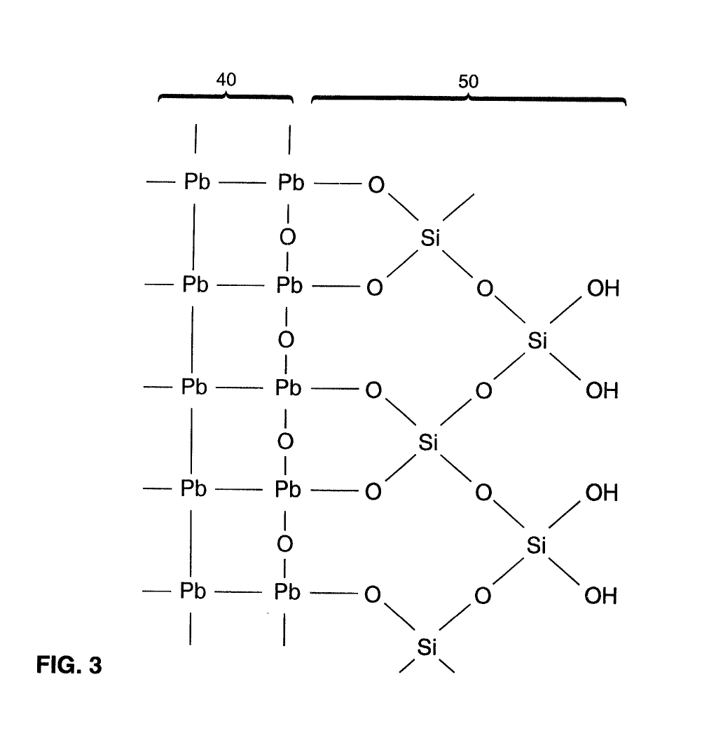

Referring more specifically to the drawings, for illustrative purposes the present invention is embodied in the apparatus generally shown in FIG. 2 through FIG. 3, where like reference numbers denote like parts. It will be appreciated that the Invention may vary as to configuration and as to details of the parts without departing from the basic inventive concepts disclosed herein.

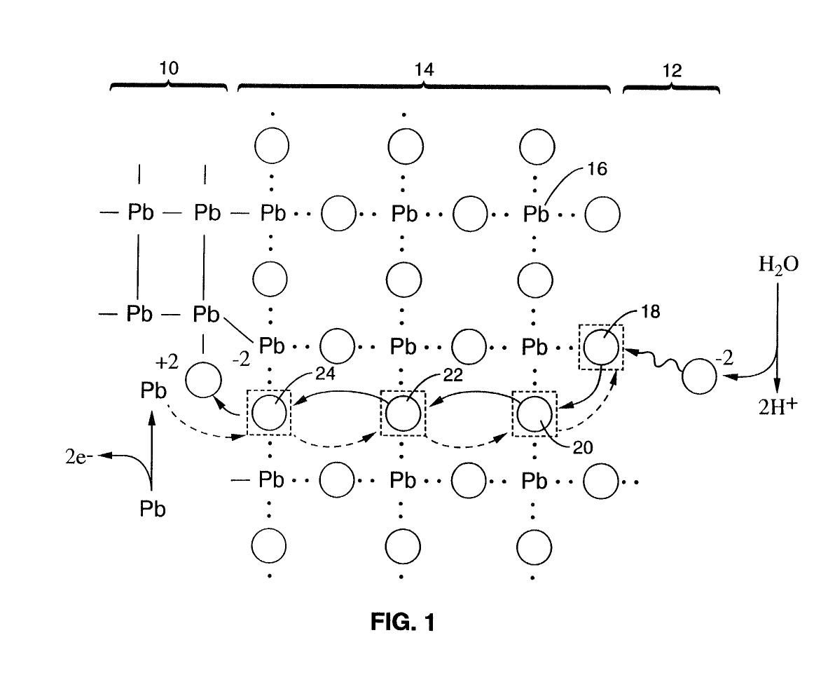

Referring first to FIG. 1, the oxidation of the lead metal components 10 exposed to the electrolyte 12 of a lead acid battery known in the art is generally represented in two dimensions. The anodic oxidation of lead (Pb) in acid solutions produces a corrosion product consisting mainly of lead dioxide (PbO₂) and small amounts of (PbO) and (PbOₓ). The corrosion layer 14 is typically composed of a matrix or lattice of lead (IV) ions (Pb⁺⁴) 16, and oxygen ions (O⁻²) 18.

A simplified view of the corrosion of lead metal under anodic polarization can be shown as follows:

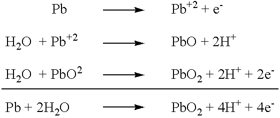

This anodic corrosion of the positive terminal and internal components results in stresses and defects that can break the seal between the lead alloy terminal and the polypropylene case. Such corrosion can lead to a reduced service life of the battery.

Oxygen ions (O⁻²) 18 are believed to move through the oxide lattice 14 from the electrolyte 12 by a vacancy mechanism. Oxygen ion (O⁻²) 18 moves within the lattice 14 from one position 20 to another 22 when a vacancy in the lattice becomes available. As shown by the arrows in FIG. 1, the jump from one position to another creates a new vacancy allowing adjacent oxygen ion 18 to jump to fill the new vacancy. The loosely bound symmetric structure of the lattice 14 results in high electronic conductivity (e⁻ or h⁺) as well as high ionic conductivity (O⁻²). Consequently, corrosion or oxidation of the lead metal components 10 occurs beneath the PbO₂ corrosion layer 14 with the free movement of oxygen ions 18 from the electrolyte 12 through the corrosion layer 14. Thus, the PbO₂ corrosion layer 14 provides very little protection to the underlying lead 10 in the anodic environment of the battery.

According to the present invention, a coating of silica (SiO₂) or alumina (Al₂O₃) on the submerged lead alloy terminals and welds results in a dramatic reduction in the oxidation of the lead metal components. It can be seen that the incorporation of silica or alumina in the corrosion layer greatly reduces the corrosion of lead metal components by limiting the movement of oxygen ions through the corrosion layer.

Turning now to FIG. 2, the incorporation of silica (SiO₂) within the lead oxide corrosion layer is generally represented. The Si—O bond is the most stable of all of the Si—X bonds. In most silica's and silicates, the silicon atom is surrounded by four oxygen atoms, forming a tetrahedral unit (SiO₄⁻⁴). A six fold octahedral coordination (SiO₆⁻⁸) has also been observed. The silica's and silicates are characterized by the sharing of the oxygen atoms from the basic SiO₄ group with adjacent groups. Similar structures are present with aluminates.

Lead metal battery components 40 exposed to electrolyte 42 in the presence of silica creates a novel oxide corrosion layer 44. The lead components 40 will initially oxidize to form a corrosion layer 44 and then the corrosion of the metal component 40 will stop. The resulting corrosion layer 44 is very non-conductive because the silica 46 binds the oxygen 48 very tightly through covalent bonds that effectively shut down oxygen ion diffusion across the corrosion layer lattice 44.

The corrosion product 44 is a lattice or matrix of lead (II) ions (Pb⁺²) 46, and silicate ions (SiO₄⁻⁴) 48 as PbSiO₃ or [PbO] [SiO₂]. It can be seen that, with silica present, lead (Pb) is only oxidized to a lead (II) ion (Pb⁺²). The Oxygen ion is immobilized or captured in the silicate anion. Therefore, Oxygen motion through the matrix as well as diffusion is significantly impeded. As a result of the reduced oxygen movement, the underlying lead metal 40 does not continue to corrode. In addition, ionic conductivity of the (O⁻²) ion is greatly reduced. Similar results are seen with hydrated alumina silicates and aluminates.

The presence of silica or alumina or both at the time of initial corrosion results in an asymmetrical lattice 44 with very low electronic conductivity (e⁻ or h⁺) as well as poor ionic conductivity and poor oxygen diffusion. Consequently, corrosion virtually ceases after the initial corrosion product 44 is formed.

Oxidation of lead component 40, in the presence of silica or alumina or both, will create a corrosion product that will shut down oxygen movement and therefore the continued oxidation of the lead metal components 40.

In the preferred embodiment, silica in the general form of (SiO₂) and a binder are deposited in a thin film 50 on the outer surface of the lead terminals and components 40 that are to be protected. The binder holds the silicon in place. Later the binder is preferably electro-oxidized away to leave colloidal silica on the surface of the terminal. It has been observed that during anodic polarization, the organic parts of the organosilane chains will be attacked and oxidized by the electrolyte. Silica, however, will resist attack by water, acid, and anodic polarization. Accordingly, the organic part of the binder is attacked leaving islands of amorphous silica evenly dispersed on the lead surface. The colloidal silica ultimately reacts with the lead and lead oxide to form a lead silicate PbSiO₃ or [PbO].[SiO₂] when exposed to electrolyte. Thus, the even dispersion of silica is incorporated into the forming lead corrosion matrix controlling growth. A similar process is used to apply alumina or alumina and silica together.

It will be understood that the silica and binder can be applied to the desired lead components of a lead acid battery by direct application by spraying, coating, dipping and other methods known in the art during the assembly of the battery or other application.

Alternatively, the silica could be deposited on the lead metal components by a process using direct silane polymerization of silicic acid. As seen in FIG. 3, the lead surface 40 is oxidized and hydroxylated by a hydroxide solution, MOH (M═Na, K etc.) The hydroxylated lead surface is then reacted with monosilicic acid (MSA or Si(OH)₄). A condensation polymerization reaction occurs resulting in a thin dense film 50 of silica. This silica polymer film 50 should be water, acid and corrosion resistant.

Accordingly, it will be seen that this invention provides a simple and effective way of eliminating excessive or unequal corrosion of the highly cold worked areas of the inside of battery side terminals that can lead to the failure of the battery and electrolyte leakage. The application of silica, alumina or both to lead components eliminates the need for expensive alloys and sophisticated battery casing designs.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A corrosion resistant lead acid battery terminal, comprising:
(a) a formed metal battery terminal having at least one surface; and
(b) a coating of corrosion inhibiting film formed over said surface of said battery terminal.

2. A battery terminal as recited in claim 1, wherein said corrosion inhibiting film contains silicon.

3. A battery terminal as recited in claim 2, wherein the corrosion inhibiting film containing silicon is in the form of SiO₂.

4. A battery terminal as recited in claim 1, wherein the corrosion inhibiting film of said coating step is room temperature vulcanized silicone rubber.

5. A battery terminal as recited in claim 1, wherein said corrosion inhibiting film contains alumina.

6. The battery terminal as recited in claim 5, wherein the corrosion inhibiting film containing alumina is in the form of Al₂O₃.

7. A battery terminal as recited in claim 1, wherein said corrosion inhibiting film contains silica and alumina.

8. A method for reducing battery component corrosion in a lead acid battery, comprising the steps of:
providing a formed metal battery component having at least one surface; and
coating a film of corrosion inhibiting film over said surface of said battery component.

9. The method as recited in claim 8, wherein the corrosion inhibiting film of said coating step contains silica.

10. The method as recited in claim 8, wherein the corrosion inhibiting film containing silica is in the form of SiO₂.

11. The method as recited in claim 8, wherein the corrosion inhibiting film of said coating step is room temperature vulcanized silicone rubber.

12. The method as recited in claim 8, wherein the corrosion inhibiting film of said coating step contains alumina.

13. The method as recited in claim 12, wherein the corrosion inhibiting film containing alumina is in the form of Al₂O₃.

14. The method as recited in claim 8, wherein the corrosion inhibiting film further comprises a colloid of silicon held in an oxidizable binder.

15. The method as recited in claim 14, wherein the corrosion inhibiting film comprises a colloid of SiO₂ held in an oxidizable binder.

16. The method as recited in claim 8, wherein the corrosion inhibiting film further comprises a colloid of an aluminum oxide held in an oxidizable binder.

17. The method as recited in claim 8, wherein the corrosion inhibiting film further comprises a colloid of Al₂O₃ held in an oxidizable binder.

18. The method as recited in claim 8, wherein the corrosion inhibiting film further comprises a colloid of alumina and silica held in an oxidizable binder.

19. The method as recited in claim 8, wherein said coating step comprises:
oxidizing said surface of said lead terminal with a hydroxide solution; and
reacting the hydroxylated surface with a monosilicic acid to form a film.

20. The method as recited in claim 8, wherein said coating step comprises:
oxidizing said surface of said lead terminal with a hydroxide solution; and
reacting the hydroxylated surface with Si(OH)₄ to form a film.

21. A method for providing corrosion resistance to lead and lead alloys in an acid electrolyte solution, comprising:
applying a coating of colloidal silica held within an oxidizable binder on to a lead metal substrate;
oxidizing said binder leaving said silica on said metal substrate; and
forming a matrix of lead silicate on the surface of said lead metal substrate.

22. The method as recited in claim 21, wherein said coating further comprises a colloid of alumina in combination with said colloidal silica held in an oxidizable binder.
